(19) United States
(12) Patent Application Publication
(10) Pub. No.: US 2025/0346307 A1
(43) Pub. Date: Nov. 13, 2025

(54) AERODYNAMIC CHARACTERISTIC CONTROL DEVICE FOR A VEHICLE

(71) Applicant: TOYOTA JIDOSHA KABISHIKI KAISHA, Toyota-shi (JP)

(72) Inventor: Fumihiko KISHIMA, Konan-shi (JP)

(73) Assignee: TOYOTA JIDOSHA KABISHIKI KAISHA, Toyota-shi (JP)

(21) Appl. No.: 19/175,344

(22) Filed: Apr. 10, 2025

(30) Foreign Application Priority Data
May 10, 2024 (JP) 2024-077288

(51) Int. Cl. B62D 35/00; B60R 16/03; B62D 37/02

(52) U.S. Cl. CPC B62D 35/007; B60R 16/03; B62D 37/02

(57) ABSTRACT

An aerodynamic characteristic control device for a vehicle includes a strip that is disposed at a rear side portion of a vehicle body and is movable in a vehicle width direction according to acceleration in a vehicle width direction applied to the vehicle body, and the strip advances and retracts with respect to an inner surface of a rear bumper so that an average distance from the inner surface of the rear bumper during straight traveling is equal to or more than a threshold value and an average distance from the inner surface of the rear bumper during turning traveling is less than the threshold value.

### CROSS REFERENCE TO RELATED APPLICATION

This application claims priority to Japanese Patent Application No. 2024-077288 filed on May 10, 2024, which is incorporated herein by reference in its entirety including the specification, claims, drawings, and abstract.

### TECHNICAL FIELD

The present disclosure relates to a structure of an aerodynamic characteristic control device that controls an air flow on an outer surface of a vehicle body.

### BACKGROUND

JPA 2022-143555 relates to an aerodynamic characteristic control device for a vehicle. JPA 2022-143555 discloses an apparatus in which a positive electrode and a negative electrode of a power source are connected to a vehicle body or a member mounted on the vehicle body, and electrons are supplied to the vehicle body or surface portions inside and outside the vehicle body to control an air flow on a side surface of the vehicle body.

However, in the apparatus described in JPA 2022-143555, a sensor for determining a vehicle state, an electric wire for generating a potential in each portion, a portion for applying a potential, a power source for changing the polarity of a potential, and the like are required. For this reason, there is a problem that the system of the apparatus described in JPA 2022-143555 becomes complicated.

Accordingly, an object of the present disclosure is to improve steering stability of a vehicle with a simple configuration.

### SUMMARY

An aerodynamic characteristic control device for a vehicle according to an embodiment of the present disclosure includes an electrically conductive component disposed on a rear side portion of a vehicle body and configured to be movable in a vehicle width direction according to an acceleration applied in the vehicle width direction to the vehicle body. The electrically conductive component moves in the vehicle width direction such that the electrically conductive component advances or retracts with respect to the inner surface of the vehicle body to maintain a distance between the electrically conductive component and an inner surface of the vehicle body equal to or larger than a threshold value during straight traveling and the distance smaller than the threshold value during turning.

According to this configuration, it is possible to cause the electrically conductive component to advance toward the inner side surface of the vehicle body during turning travel, and to attract the airflow flowing along the outer side surface of the rear portion of the vehicle body to the outer side surface of the vehicle body. Accordingly, it is possible to suppress the disturbance of the airflow in the rear of the vehicle body and to suppress the generation of the fluctuation force in the vehicle width direction. In addition, since the distance between the electrically conductive component and the inner surface of the vehicle body is maintained to be equal to or larger than the threshold value during straight traveling, it is possible to prevent the airflow on the outer surface of the rear portion of the vehicle body from being attracted to the outer surface of the rear portion of the vehicle body during straight traveling. Therefore, it is possible to prevent the aerodynamic center of the vehicle from moving rearward during straight traveling. Accordingly, the present disclosure can improve steering stability during turning traveling and straight traveling with a simple configuration.

In the aerodynamic characteristic control device for a vehicle according to the present disclosure may include a base member attached to the inner surface of the vehicle body. One end of the electrically conductive component may be rotatably attached to the base member, and the other end of the electrically conductive component may be swung in the vehicle width direction due to rotation of the one end of the electrically conductive component with respect to the base member.

Thus, the electrically conductive component can be moved back and forth with respect to the inner surface of the vehicle body by swinging the electrically conductive component with a simple configuration. Accordingly, steering stability during turning and straight traveling can be improved with a simple configuration.

In the aerodynamic characteristic control device for a vehicle according to the present disclosure may include a base member attached to the inner surface of the vehicle body, and a groove portion may be provided to the inner surface of the vehicle body. One end of the electrically conductive component may be rotatably attached to the base member, and the other end of the electrically conductive component may be slidably inserted into the groove portion. The electrically conductive component further may include a bendable joint portion at a position located between the one end and the other end of the electrically conductive component. And when the one end of the electrically conductive component rotates with respect to the base member, the other end of the electrically conductive component may be slid within the groove portion to swing the joint portion in the vehicle width direction.

According to this configuration, the electrically conductive component can be disposed in the vehicle exterior article having a small internal space.

In the aerodynamic characteristic control device for a vehicle according to the present disclosure, at least a part of the electrically conductive component may have the same curved shape as a curved shape of the inner surface of the vehicle body.

Accordingly, the electrically conductive member can be brought into close contact with the inner surface of the vehicle body during turning. As a result, the attraction force of the airflow flowing along the outer surface of the rear portion of the vehicle body to the outer surface of the vehicle body increases, and the disturbance of the airflow in the rear portion of the vehicle body can be further suppressed, so that the generation of the fluctuation force in the vehicle width direction can be further suppressed.

In the aerodynamic characteristic control device for a vehicle according to the present disclosure may include a weight attached to the electrically conductive component.

By adjusting the position at which the weight is attached, the steering stability can be adjusted by adjusting the timing at which the conductive component approaches the inner surface of the vehicle body.

The present disclosure can improve steering stability of a vehicle with a simple configuration.

### BRIEF DESCRIPTION OF DRAWINGS

FIG. 1 is a perspective view showing an aerodynamic characteristic control device according to a first embodiment attached to a vehicle body;

FIG. 2 is a cross-sectional view of the aerodynamic characteristic control device and the vehicle body shown in FIG. 1, and is a cross-sectional view taken along line A-A of FIG. 1;

FIG. 3 is an enlarged cross-sectional view of a portion B shown in FIG. 2;

FIG. 4 is a plan view showing an air flow on a side surface of the vehicle when the vehicle equipped with the aerodynamic characteristic control device according to the first embodiment is traveling straight;

FIG. 5 is a plan view showing the air flow on the left side surface of the vehicle when the vehicle equipped with the aerodynamic characteristic control device according to the first embodiment is turning to the right;

FIG. 6 is a cross-sectional view of a vehicle body and a modification of the aerodynamic characteristic control device shown in FIGS. 1 and 2;

FIG. 7 is an enlarged cross-sectional view of an aerodynamic characteristic control device according to a second embodiment;

FIG. 8 is a perspective view showing an aerodynamic characteristic control device according to a third embodiment attached to a vehicle body;

FIG. 9 is an elevation view of the aerodynamic characteristic control device shown in FIG. 8 as viewed from the left side of the vehicle;

FIG. 10 is an elevation view showing a modification of the aerodynamic characteristic control device shown in FIG. 9;

FIG. 11 is a perspective view showing an aerodynamic characteristic control device according to a fourth embodiment disposed inside a side spoiler of a vehicle body;

FIG. 12 is a cross-sectional view of the aerodynamic characteristic control device shown in FIG. 11 and the vehicle body, and is a cross-sectional view taken along line C-C shown in FIG. 11;

FIG. 13 is a cross-sectional view showing a modification of the aerodynamic characteristic control device shown in FIG. 12;

FIG. 14 is a perspective view showing an aerodynamic characteristic control device according to a fifth embodiment disposed inside a side spoiler of a vehicle body;

FIG. 15 is a cross-sectional view of the aerodynamic characteristic control device shown in FIG. 14 and the vehicle body, and is a cross-sectional view taken along the line D-D shown in FIG. 14;

FIG. 16 is a cross-sectional view of an aerodynamic characteristic control device and a vehicle body according to a sixth embodiment;

FIG. 17 is a cross-sectional view of an aerodynamic characteristic control device and a vehicle body according to a seventh embodiment.

### DESCRIPTION OF EMBODIMENTS

Hereinafter, an aerodynamic characteristic control device 20 according to a first embodiment will be described with reference to the drawings. First, the vehicle 100 including the aerodynamic characteristic control device 20 will be described. Note that FR, UP, and LH shown in the drawings indicate a front side, an upper side, and a left side of the vehicle 100, respectively. The opposite directions of FR, UP, and LH indicate the rear side, the lower side, and the right side. Hereinafter, in the case where the front-rear direction, the left-right direction, and the up-down direction are simply used, the front-rear direction, the left-right direction, and the up-down direction of the vehicle 100 are indicated unless otherwise specified. The front-rear, left-right, and up-down directions of the vehicle 100 are the front-rear, left-right, and up-down directions of the vehicle body 10.

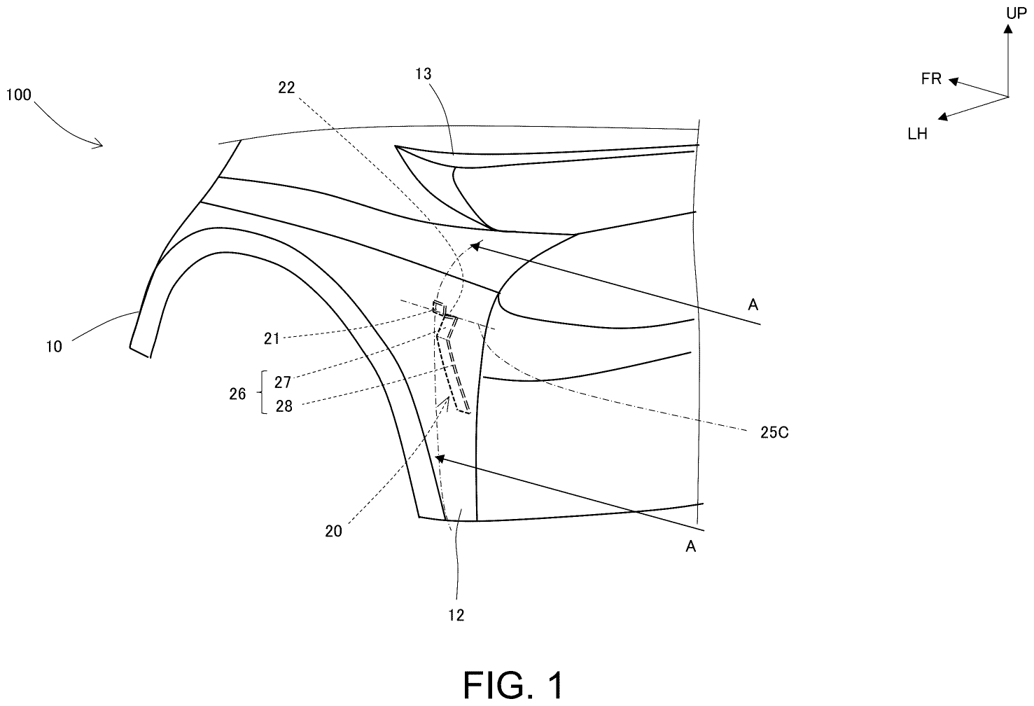

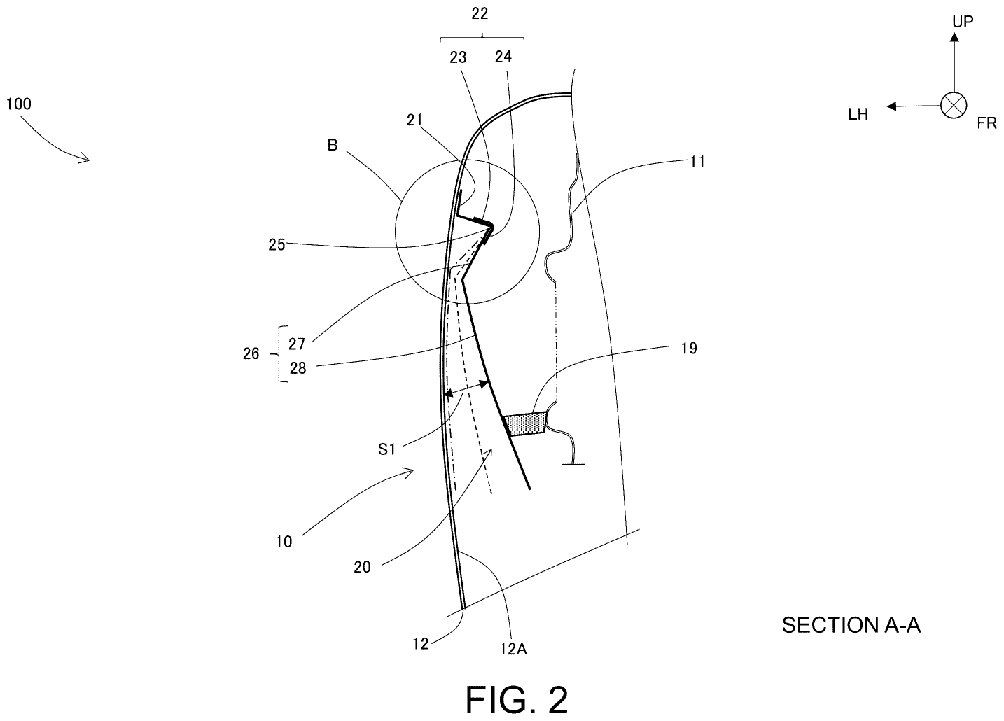

As shown in FIG. 1, a vehicle 100 includes a vehicle body 10. The vehicle body 10 includes a metal frame (not shown) disposed therein and an exterior member attached to the outside of the frame. As shown in FIG. 1, a rear bumper 12 made of resin is attached to a lower left rear portion of the vehicle body 10. The rear bumper 12 has a shape extending from the rear of the vehicle body 10 to the side of the rear portion of the vehicle body 10. As shown in FIG. 2, the left side surface of the rear bumper 12 covers the vehicle width direction outer side of the metal side member 11 constituting the frame. Further, as shown in FIG. 1, a tail lamp 13 is attached to a left end portion of the vehicle body 10 at the rear and the center in the vertical direction.

As shown in FIGS. 1 and 2, the aerodynamic characteristic control device 20 of the first embodiment is attached to the inside of the rear bumper 12. The aerodynamic characteristic control device 20 includes a base member 21, a connecting member 22, and a strip 26 which is an electrically conductive component. The base member 21 is an L-shaped plate member. A first flange of the base member 21 is fixed to the left inner surface 12A of the rear bumper 12. A second flange of the base member 21 extends inward in the vehicle width direction from the first flange.

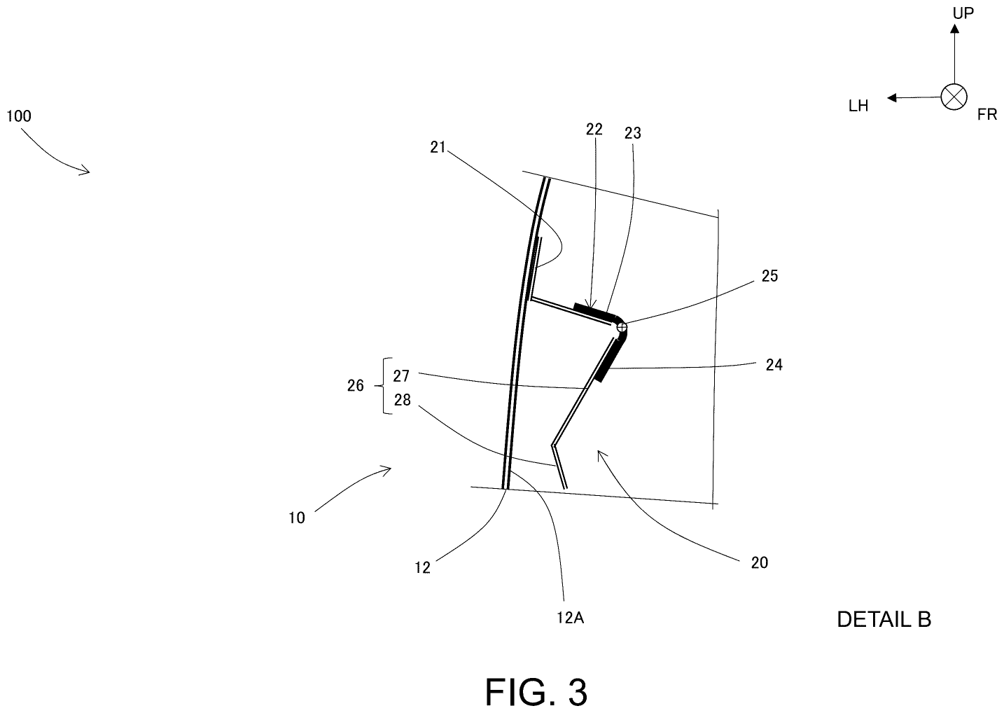

As shown in FIGS. 2 and 3, the connecting member 22 connects the second flange of the base member 21 and the strip 26. The connecting member 22 includes a fixing portion 23 and a rotating portion 24. As shown in FIG. 3, the fixing portion 23 is a portion fixed to the second flange of the base member 21. The rotating portion 24 is a portion to which the strip 26 is attached. The rotating portion 24 rotates around a rotation axis 25 between the fixing portion 23 and the rotating portion 24. As a result, the rotating portion 24 is rotatable with respect to the base member 21. The connecting member 22 may be made of a thin cloth such as polyethylene or nylon. In this case, the cloth between the fixing portion 23 fixed to the base member 21 and the rotating portion 24 attached to the strip 26 constitutes the rotation axis 25. As shown in FIG. 1, in the aerodynamic characteristic control device 20 of the first embodiment, the center line 25C of the rotation axis 25 horizontally extends in the vehicle front-rear direction. Here, the center line 25C is an imaginary line.

As shown in FIG. 2, the strip 26 is a bent plate member, and includes an upper arm portion 27 and a lower advancing/retracting portion 28. The strip 26 may be formed of, for example, a metal plate material such as aluminum. The upper end of the arm portion 27 is connected to the rotating portion 24, and the arm portion 27 rotates around the rotation axis 25. The advancing/retracting portion 28 is connected to the lower end of the arm portion 27, is bent from the lower end, and extends downward. The advancing/retracting portion 28 has the same curved surface shape as the curved surface shape of the inner surface 12A of the rear bumper 12. Similarly to the inner surface 12A, the advancing/retracting portion 28 is curved slightly convex toward the left.

A stopper 19 made of resin is provided at a lower portion of the side member 11. The stopper 19 inhibits rightward movement of the strip 26.

Here, the operation of the aerodynamic characteristic control device 20 when the vehicle 100 is traveling straight and when it is turning to the right will be described.

When the vehicle 100 is traveling straight, acceleration in the left-right direction is not applied to the strip 26. Therefore, as shown in FIG. 2, the strip 26 hangs downward from the tip of the base member 21 by gravity, and the lower end portion of the advancing/retracting portion 28 abuts against the stopper 19. As described above, when the vehicle 100 is traveling straight, the advancing/retracting portion 28 of the strip 26 is separated from the inner surface 12A of the rear bumper 12. At this time, the average distance S1 between the central portion of the advancing/retracting portion 28 and the inner surface 12A is larger than the threshold value.

When the vehicle 100 turns to the right, as shown by the broken line in FIG. 2, the upper end of the arm portion 27 of the strip 26 rotates clockwise about the rotation axis 25 by the acceleration toward the left. The advancing/retracting portion 28 of the strip 26 is close to the inner surface 12A of the rear bumper 12. That is, when the upper end of the strip 26 rotates with respect to the base member 21, the lower end of the strip 26 swings in the vehicle width direction, and the advancing/retracting portion 28 approaches the inner surface 12A. As a result, the average distance S1 between the strip 26 and the inner surface 12A becomes less than the threshold value. When the acceleration toward the left increases, the advancing/retracting portion 28 comes into contact with the inner surface 12A as indicated by a one-dot chain line in FIG. 2. As described above, since the advancing/retracting portion 28 has the same curved surface shape as the curved surface shape of the inner surface 12A of the rear bumper 12, the strip 26 is in close contact with the inner surface 12A.

The air flowing on the outer surface of the rear bumper 12 is charged. Therefore, when the advancing/retracting portion 28 of the strip 26 comes into close contact with the inner surface 12A during turning, the air flowing on the outer surface of the rear bumper 12 is attracted to the outer surface of the rear bumper 12 by electrostatic induction with respect to the air. On the other hand, when the advancing/retracting portion 28 of the strip 26 is separated from the inner surface 12A as in the straight traveling of the vehicle 100, electrostatic induction with respect to the air does not occur. Therefore, during straight traveling, the air flowing on the outer surface of the rear bumper 12 is not attracted to the outer surface of the rear bumper 12.

As described above, the strip 26 advances and retracts with respect to the inner surface 12A of the rear bumper 12 so that the average distance S1 between the rear bumper 12 and the inner surface 12A is equal to or more than the threshold value during straight traveling, and the average distance S1 between the rear bumper 12 and the inner surface 12A is less than the threshold value during turning traveling. Here, the threshold value may be determined so as not to cause attraction of air due to electrostatic induction, and may be selected in a range of, for example, 1 mm to several mm.

In the above description, the threshold value is set for the average distance S1 between the strip 26 and the inner surface 12A. For example, the distance between the upper end of the advancing/retracting portion 28 and the inner surface 12A may be defined as the shortest distance, and the threshold value may be set for the shortest distance. Alternatively, the distance between the center-of-gravity position of the strip 26 and the inner surface 12A may be defined as the center-of-gravity distance, and a threshold may be set for the center-of-gravity distance.

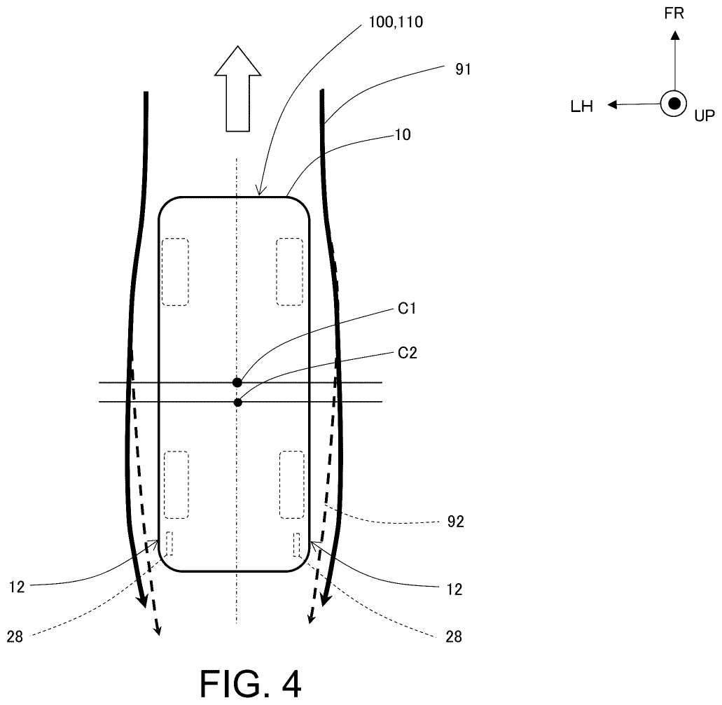

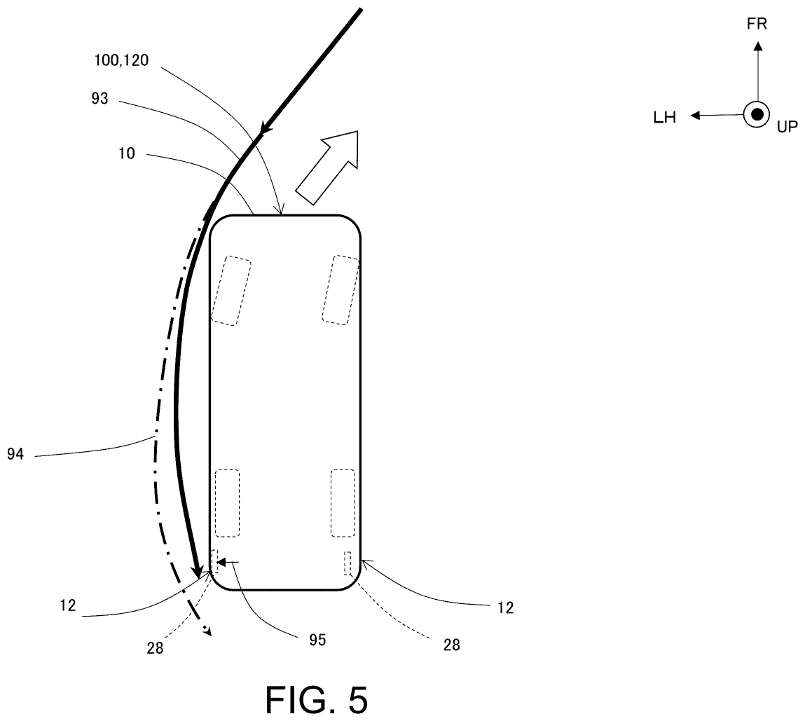

Here, the flow of air on the side surfaces of the vehicles 100, 110, and 120 when the vehicle 100 is traveling straight and when turning to the right will be described with reference to FIGS. 4 and 5. In FIGS. 4 and 5, thick arrows 91 and 93 indicate the flow of air on the side surface of the vehicle 100 when the vehicle 100 travels straight or turns. On the other hand, an arrow 92 in a broken line in FIG. 4 and a one-dot chain line 94 in FIG. 5 indicate the flow of air on the side surfaces of the vehicles 110 and 120 of the related art. The vehicles 110 and 120 are the same as the vehicle 100 except for the configuration of the aerodynamic characteristic control device.

When the vehicle 100 is traveling straight as indicated by an outline arrow in FIG. 4, the traveling wind flows along the left and right side surfaces of the vehicle 100 and flows out from the rear of the vehicle 100, as indicated by a thick arrow 91 in FIG. 4. During straight traveling, the advancing/retracting portion 28 of the strip 26 is separated from the inner surface 12A of the rear bumper 12, and the average distance S1 is equal to or larger than the threshold value. Therefore, the air is not attracted by electrostatic induction, and the air flowing on the outer surface of the rear bumper 12 is not attracted to the outer surface of the rear bumper 12. Therefore, on the outer surface of the rear bumper 12, the air flows away from the outer surface of the rear bumper 12. The aerodynamic center of the vehicle 100 at this time is C1 shown in FIG. 4.

Here, a broken-line arrow 92 in FIG. 4 indicates an air flow on a side surface of the vehicle 110 to which an aerodynamic characteristic control device (not shown) of the related art is attached. The aerodynamic characteristic control device of the related art may be a device in which a conductor is directly attached to the inner surface 12A of the rear bumper 12. In this case, the average distance between the inner surface 12A and the conductor is zero, which is less than the threshold value, and the attraction of air by electrostatic induction occurs. Therefore, in the vehicle 110, even during straight traveling, the air flowing on the outer surface of the rear bumper 12 is attracted to the outer surface of the rear bumper 12 by electrostatic induction. The aerodynamic center of the vehicle 110 at this time is C2 behind C1 as shown in FIG. 4. It is known that the steering stability deteriorates when the aerodynamic center moves backward during straight traveling.

On the other hand, in the vehicle 100 equipped with the aerodynamic characteristic control device 20 according to the first embodiment, the average distance S1 between the strip 26 and the inner surface 12A is equal to or larger than the threshold value during straight traveling, and the attraction of air due to electrostatic induction does not occur. Therefore, in the vehicle 100, the aerodynamic center of the vehicle 100 does not move backward during straight traveling. Accordingly, the aerodynamic characteristic control device 20 can suppress a decrease in steering stability during straight traveling, and secure steering stability during straight traveling.

As shown in FIG. 5, in a state where the vehicle 120 not equipped with the aerodynamic characteristic control device 20 is turning to the right, as shown by a one-dot chain line 94 in FIG. 5, the traveling wind flows so as to go around to the left side surface of the vehicle 120 from the right front side of the vehicle 120. Then, the traveling wind flows away from the left side surface of the vehicle 120 toward the rear of the vehicle 120, and flows out from the left rear of the vehicle 120. At this time, since the distance between the left rear outer surface of the vehicle 120 and the flow of air is large, turbulence occurs in the flow when the air flows out from the rear of the vehicle 120. The fluctuating force thereby acts on the left rear side of the vehicle 120. This reduces the steering stability of the vehicle 120.

On the other hand, in the case of the vehicle 100 equipped with the aerodynamic characteristic control device 20, the advancing/retracting portion 28 of the strip 26 comes into contact with the inner surface 12A of the rear bumper 12 when turning to the right. As a result, the air charged by electrostatic induction is attracted to the outer surface of the rear bumper 12. Therefore, the distance between the left rear outer surface of the vehicle 100 and the flow of air is reduced, and the disturbance of the flow when the air flows out from the rear of the vehicle 100 is reduced. Then, the fluctuation force acting on the vehicle 100 is reduced due to the disturbance of the air flow, and the steering stability is improved.

As described above, the aerodynamic characteristic control device 20 causes the strip 26 to advance with respect to the inner surface 12A of the rear bumper 12 so that the average distance S1 between the strip 26 and the inner surface 12A is less than the threshold value during turning of the vehicle 100. Accordingly, the airflow flowing along the outer surface of the rear portion of the vehicle body 10 is attracted to the outer surface of the vehicle body 10. As a result, the aerodynamic characteristic control device 20 can suppress turbulence of the air flow behind the vehicle body and can suppress generation of a fluctuation force in the vehicle width direction. In addition, the aerodynamic characteristic control device 20 moves the strip 26 away from the inner surface 12A of the rear bumper 12 so that the average distance S1 between the strip 26 and the inner surface 12A is equal to or greater than the threshold value during straight traveling. Therefore, the aerodynamic characteristic control device 20 can prevent the airflow on the outer surface of the rear portion of the vehicle body from being attracted to the outer surface of the rear portion of the vehicle body during straight traveling. Accordingly, the aerodynamic characteristic control device 20 can ensure steering stability during straight traveling by preventing the aerodynamic center of the vehicle 100 from moving rearward during straight traveling. As described above, the aerodynamic characteristic control device 20 can improve the steering stability of the vehicle 100 during turning travel and straight travel with a simple configuration.

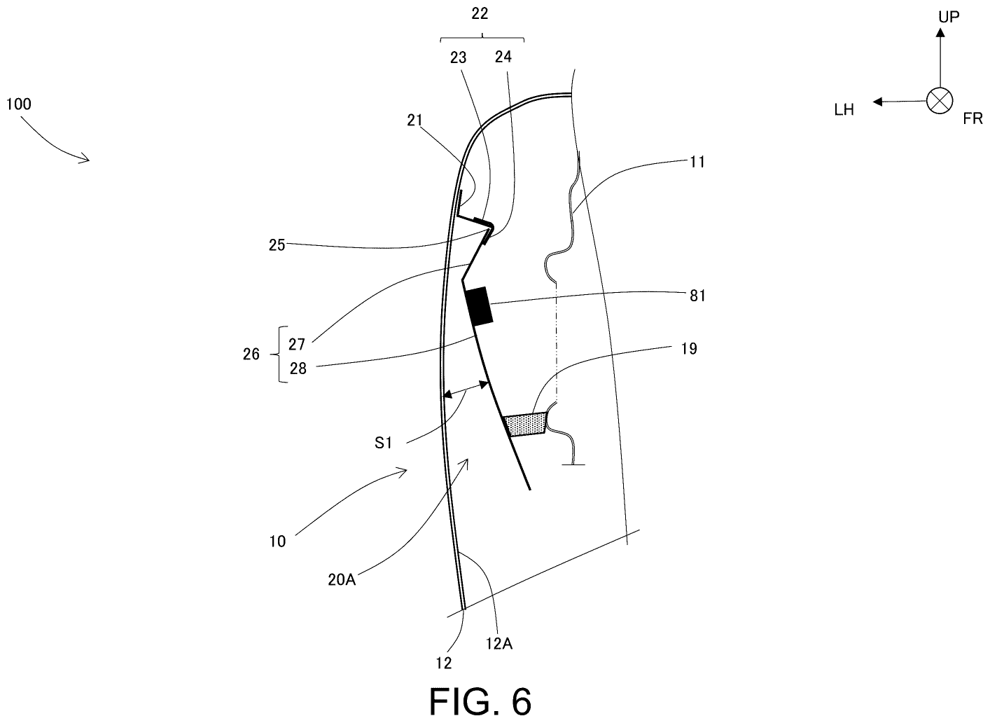

Next, an aerodynamic characteristic control device 20A, which is a modification of the aerodynamic characteristic control device 20, will be described with reference to FIG. 6. First, the same components as those of the aerodynamic characteristic control device 20 described with reference to FIGS. 1 to 5 are denoted by the same reference numerals, and description thereof will be omitted.

As shown in FIG. 6, in the aerodynamic characteristic control device 20A, a weight 81 is attached to the advancing/retracting portion 28 of the strip 26.

In this way, the distance between the rotation axis 25 and the position of the center of gravity of the strip 26 can be adjusted by attaching the weight 81. Thus, the timing at which the strip 26 approaches the inner surface 12A of the rear bumper 12 can be adjusted. For example, when the weight 81 is disposed near the rotation axis 25, the advancing/retracting portion 28 can be brought close to the inner surface 12A of the rear bumper 12 even with a small acceleration in the direction. Conversely, when the weight 81 is disposed at a position far from the rotation axis 25, the advancing/retracting portion 28 can be brought close to the inner surface 12A of the rear bumper 12 when a large lateral acceleration is applied. Accordingly, the timing at which the strip 26 approaches the inner surface 12A can be matched with the timing at which the steering stability of the vehicle 100 becomes high.

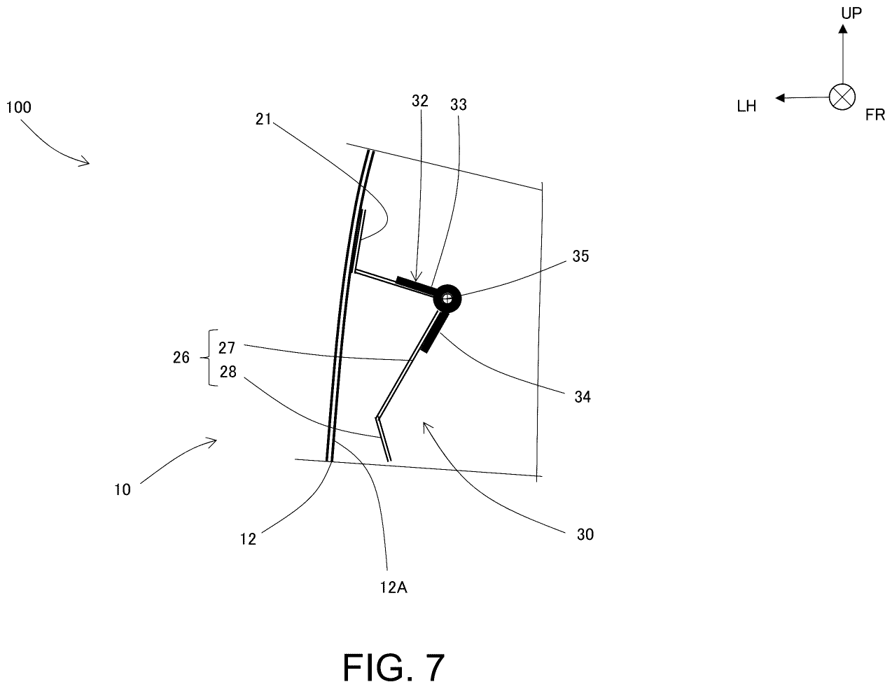

Next, an aerodynamic characteristic control device 30 according to a second embodiment will be described with reference to FIG. 7. First, the same components as those of the aerodynamic characteristic control device 20 described with reference to FIGS. 1 to 5 are denoted by the same reference numerals, and description thereof will be omitted.

As shown in FIG. 7, in the aerodynamic characteristic control device 30, the connecting member 22 of the aerodynamic characteristic control device 20 described with reference to FIG. 2 is replaced with a connecting member 32 having another configuration. The other configuration is the same as the configuration of the aerodynamic characteristic control device 20 described above.

As shown in FIG. 7, the connecting member 32 is formed of a hinge. A rotating shaft 35 is disposed between the fixed portion 33 and the rotating portion 34. The rotating shaft 35 is fixed to the fixed portion 33, and the rotating portion 34 is rotatable around the rotating shaft 35. The fixed portion 33 is fixed to the base member 21. The arm portion 27 of the strip 26 is attached to the rotating portion 34. Accordingly, the rotating portion 34 is rotatable with respect to the base member 21.

The operation/effect of the aerodynamic characteristic control device 30 is the same as that of the aerodynamic characteristic control device 20 described above.

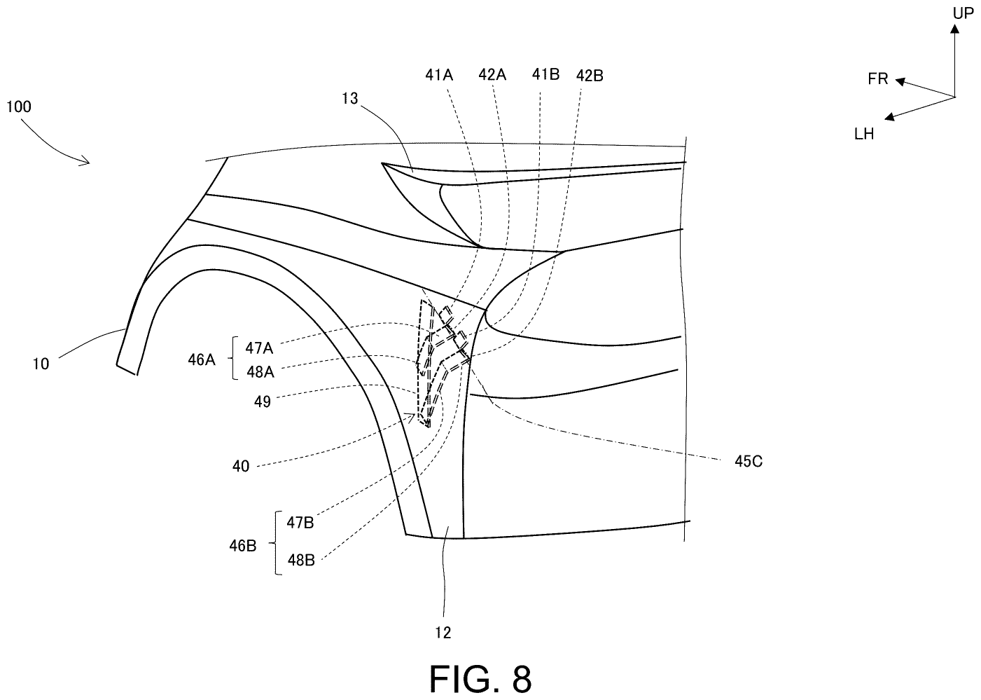

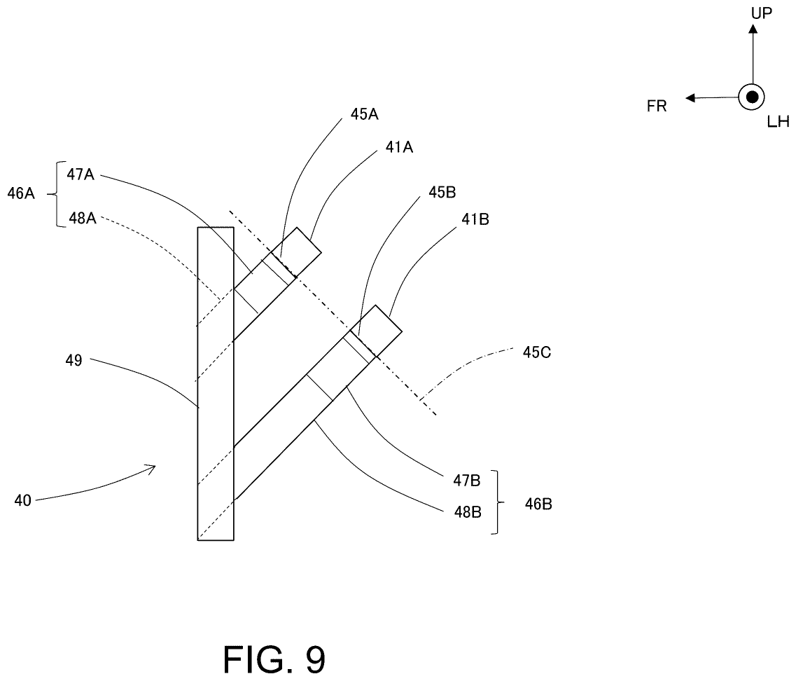

Next, an aerodynamic characteristic control device 40 according to a third embodiment will be described with reference to FIGS. 8 and 9. Description of the same portions as those of the aerodynamic characteristic control device 20 described above with reference to FIGS. 1 to 5 will be omitted.

As shown in FIGS. 8 and 9, the aerodynamic characteristic control device 40 includes two base members 41A and 41B, two connecting members 42A and 42B, two strips 46A and 46B, and a common advancing/retracting plate 49. The connecting members 42A and 42B are attached to the base members 41A and 41B so that the rotation axises 45A and 45B are coaxially inclined forward and upward. A common center line of the rotation axises 45A and 45B is 45C. Here, the center line 45C is an imaginary line.

The strips 46A and 46B include arm portions 47A and 47B and advancing/retracting portions 48A and 48B. The arm portions 47A and 47B are attached to the connecting members 42A and 42B so as to extend in an inclined direction with respect to the vehicle vertical direction at right angles to the rotation axises 45A and 45B. The advancing/retracting portions 48A and 48B are connected to the lower ends of the arm portions 47A and 47B and extend in the inclined direction. The advancing/retracting plate 49 is a plate member made of metal such as aluminum, and is attached to the vehicle width direction outer sides of the advancing/retracting portions 48A and 48B so as to extend in the vehicle vertical direction. The strips 46A and 46B and the advancing/retracting plate 49 constitute an electrically conductive component of the aerodynamic characteristic control device 40.

The strips 46A and 46B rotate about the rotation axises 45A and 45B to advance and retract the advancing/retracting portions 48A and 48B and the advancing/retracting plate 49 with respect to the inner surface 12A of the rear bumper 12. Then, the advancing/retracting portions 48A and 48B and the advancing/retracting plate 49 move in the vehicle width direction so as to advance and retract with respect to the inner surface 12A of the rear bumper 12 so that the average distance S1 between the rear bumper 12 and the inner surface 12A is equal to or more than the threshold value during straight traveling, and the average distance S1 between the rear bumper 12 and the inner surface 12A is less than the threshold value during turning traveling.

Thus, the aerodynamic characteristic control device 40 has the same operation/effect as the aerodynamic characteristic control device 20.

In addition, since the aerodynamic characteristic control device 40 brings the advancing/retracting portions 48A and 48B of the two strips 46A and 46B and the advancing/retracting plate 49 close to the inner surface 12A of the rear bumper 12, the attraction force of air due to electrostatic induction becomes larger than that of the aerodynamic characteristic control device 20 described above. Therefore, the aerodynamic characteristic control device 40 can more strongly attract the air to the outer surface of the rear bumper 12 than the aerodynamic characteristic control device 20, and can further improve the steering stability.

In addition, since the rotation axises 45A and 45B are inclined forward and upward, the aerodynamic characteristic control device 40 can bring the advancing/retracting portions 48A and 48B and the advancing/retracting plate 49 close to the inner surface 12A of the rear bumper 12 even when the acceleration in the lateral direction is small. Therefore, the steering stability can be further improved by applying to the vehicle 100 that is susceptible to the influence of the fluctuating force during turning travel.

Further, in the aerodynamic characteristic control device 40, since the rotation axises 45A and 45B are inclined forward and upward, the positions of the advancing/retracting portions 48A and 48B and the advancing/retracting plate 49 can be stabilized. As a result, the aerodynamic characteristic control device 40 can suppress fluctuations in the attraction force of air due to electrostatic induction, and can further improve steering stability.

In the above description, it is assumed that one aerodynamic characteristic control device 40 is attached to the vehicle 100, but the present disclosure is not limited thereto. For example, two aerodynamic characteristic control device 40 may be disposed inside the rear bumper 12, or the aerodynamic characteristic control device 40 in which the base members 41A and 41B, the connecting members 42A and 42B, the strips 46A and 46B, and the advancing/retracting plate 49 are reduced in size may be disposed side by side in the vertical direction inside another vehicle exterior article made of resin.

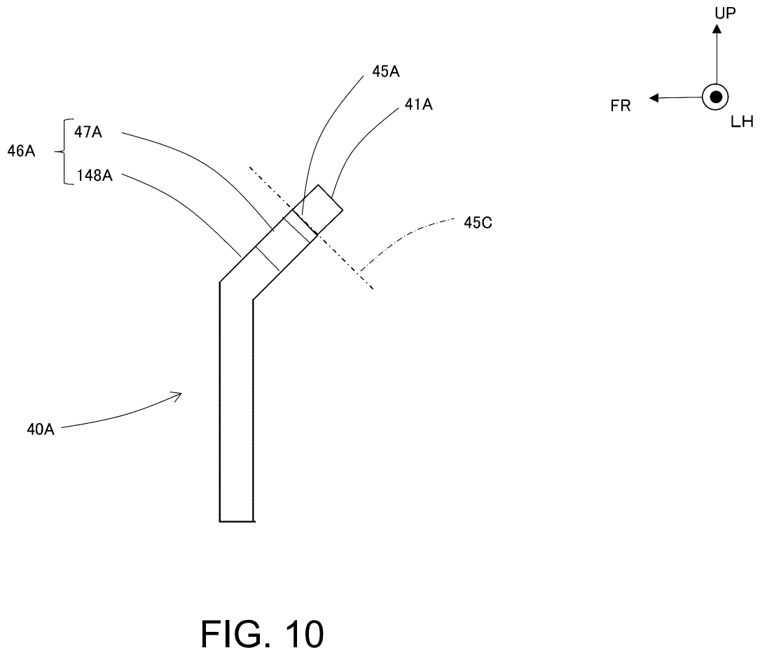

Further, as in an aerodynamic characteristic control device 40A shown in FIG. 10, the rotation axis 45A may be disposed to be inclined, and the advancing/retracting portion 148A may be configured to be bent from the lower end of the arm portion 47A and extend downward. Also in this case, since the rotation axis 45A is inclined forward and upward, the position of the advancing/retracting portion 148A can be stabilized, and the steering stability can be improved.

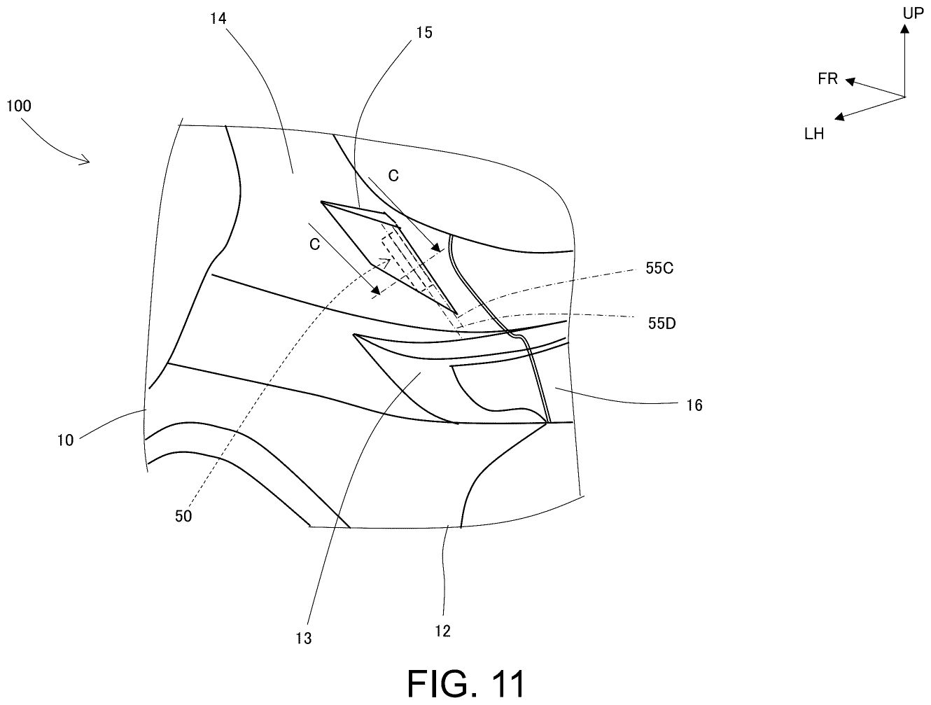

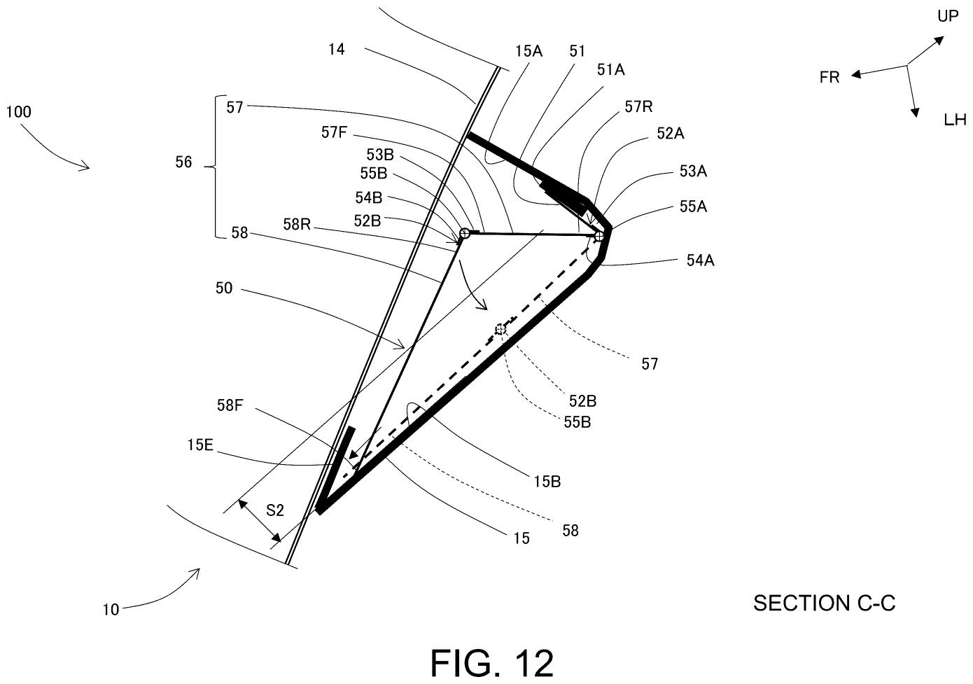

Next, an aerodynamic characteristic control device 50 according to a fourth embodiment will be described with reference to FIGS. 11 and 12. As shown in FIGS. 11 and 12, in the vehicle 100, a side spoiler 15 made of resin is attached to the outer side of the quarter panel 14 on the rear side, and the aerodynamic characteristic control device 50 is disposed inside the side spoiler 15. As shown in FIG. 12, a groove portion 15E is provided at a front end portion of the side spoiler 15.

As illustrated in FIG. 12, the aerodynamic characteristic control device 50 includes a base member 51, a first connecting member 52A, a second connecting member 52B, and a strip 56 that is a conductive component. The strip 56 includes a first strip 57 and a second strip 58. The first strip 57 and the second strip 58 are plate members made of metal such as aluminum. The first strip 57 and the second strip 58 have the same curved surface shape as the curved surface shape of the left inner surface 15B of the side spoiler 15.

The base member 51 is fixed to the rear inner surface 15A of the side spoiler 15 with a double-sided tape 51A. The first connecting member 52A is connected to the left end of the base member 51. Similarly to the connecting member 22 of the aerodynamic characteristic control device 20 described above, the first connecting member 52A includes a first fixing portion 53A, a first rotating portion 54A, and a first rotation axis 55A. Here, as shown in FIG. 11, the first rotation axis 55A is disposed so that the center line 55C is inclined forward and upward with respect to the horizontal plane. Returning to FIG. 12, the first fixing portion 53A is fixed to the base member 51. The first rotating portion 54A rotates with respect to the base member 51 about the first rotation axis 55A. A rear end 57R of the first strip 57 is attached to the first rotating portion 54A. The first strip 57 is rotatable with respect to the base member 51 about the first rotation axis 55A.

The second connecting member 52B has the same structure as the first connecting member 52A, and includes a second fixing portion 53B, a second rotating portion 54B, and a second rotation axis 55B. The second rotating portion 54B rotates around the second rotation axis 55B. Here, as shown in FIG. 11, the second rotation axis 55B is disposed so that the center line 55D is inclined forward and upward with respect to the horizontal plane. The second rotation axis 55B is disposed parallel to the first rotation axis 55A.

Returning to FIG. 12, the second fixing portion 53B is fixed to the front end 57F of the first strip 57. The rear end 58R of the second strip 58 is attached to the second rotating portion 54B. Thus, the second strip 58 is rotatable with respect to the first strip 57 about the second rotation axis 55B. The front end 58F of the second strip 58 is inserted into the groove portion 15E of the side spoiler 15.

In this way, the second connecting member 52B constitutes a bendable joint portion disposed between the rear end 57R of the first strip 57 and the front end 58F of the second strip 58. Here, the first strip 57 and the second strip 58 constitute a strip 56 which is an electrically conductive component. Accordingly, the rear end 57R of the first strip 57 constitutes one end of the electrically conductive component, and the front end 58F of the second strip 58 constitutes the other end of the electrically conductive component. The second connecting member 52B constitutes a bendable joint portion disposed between one end and the other end of the conductive component.

As shown in FIG. 12, when the vehicle 100 is traveling straight, the first strip 57 and the second strip 58 are bent toward the quarter panel 14 by gravity. At this time, the average distance S2 between the first strip 57 and the second strip 58 and the left inner surface 15B of the side spoiler 15 is equal to or greater than the threshold value.

When the vehicle 100 turns to the right, if an acceleration in the left direction is applied, the first strip 57 rotates counterclockwise around the first rotation axis 55A and approaches the left inner surface 15B of the side spoiler 15, as indicated by a broken line in FIG. 12. At this time, the second strip 58 rotates clockwise with respect to the first strip 57 about the second rotation axis 55B. The front end 58F slides in the groove portion 15E toward the front of the vehicle. That is, when the acceleration in the left direction is applied, the front end 58F of the second strip 58 slides inside the groove portion 15E when the rear end 57R of the first strip 57 rotates with respect to the base member 51. As a result, the second connecting member 52B swings leftward in the vehicle width direction, and the front end 57F of the first strip 57 and the rear end 58R of the second strip 58 approach the left inner surface 15B of the side spoiler 15. Therefore, the average distance S2 between the first strip 57 and the second strip 58 and the left inner surface 15B of the side spoiler 15 is less than the threshold value. When the acceleration in the left direction increases, the first strip 57 and the second strip 58 come into contact with the left inner surface 15B.

When the first strip 57 and the second strip 58 are close to or in contact with the left inner surface 15B, the air charged by electrostatic induction is attracted to the left outer surface of the side spoiler 15. This reduces turbulence of air flowing out from the rear of the vehicle 100 when the vehicle 100 is turning to the right. Therefore, the fluctuating force acting on the vehicle 100 due to the disturbance of the air flow is reduced, and the steering stability during turning travel is improved.

In addition, the aerodynamic characteristic control device 50 moves the first strip 57 and the second strip 58 away from the left inner surface 15B of the side spoiler 15 so that the average distance S2 between the first strip 57 and the second strip 58 and the left inner surface 15B of the side spoiler 15 is equal to or greater than the threshold value during straight traveling. Therefore, the aerodynamic characteristic control device 50 can prevent the airflow on the outer surface of the rear portion of the vehicle body from being attracted to the outer surface of the rear portion of the vehicle body during straight traveling. Accordingly, the aerodynamic characteristic control device 50 can ensure steering stability during straight traveling by preventing the aerodynamic center of the vehicle 100 from moving rearward during straight traveling. As described above, the aerodynamic characteristic control device 50 can improve the steering stability of the vehicle 100 during turning travel and straight travel with a simple configuration.

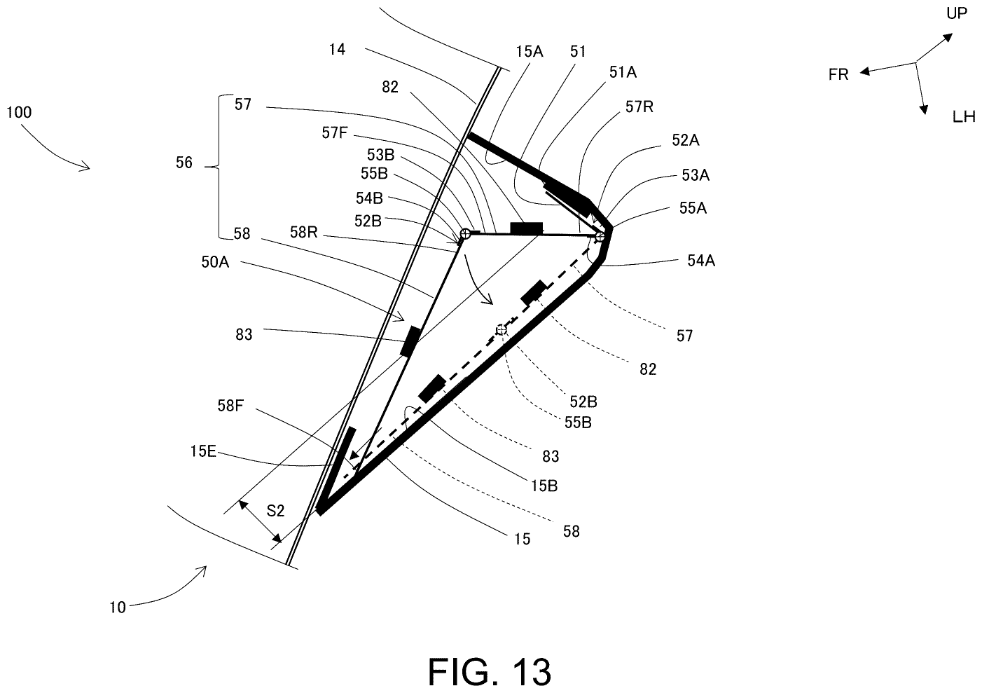

Next, an aerodynamic characteristic control device 50A of a modification of the aerodynamic characteristic control device 50 will be described with reference to FIG. 13. In the aerodynamic characteristic control device 50A, as in the aerodynamic characteristic control device 20A described with reference to FIG. 6, weights 82 and 83 are attached to the first strip 57 and the second strip 58. Similarly to the aerodynamic characteristic control device 20A, the aerodynamic characteristic control device 50A can adjust the timing at which the first strip 57 and the second strip 58 approach the left inner surface 15B of the side spoiler 15. Accordingly, the timing at which the first strip 57 and the second strip 58 approach the left inner surface 15B of the side spoiler 15 can be matched with the timing at which the steering stability of the vehicle 100 becomes high.

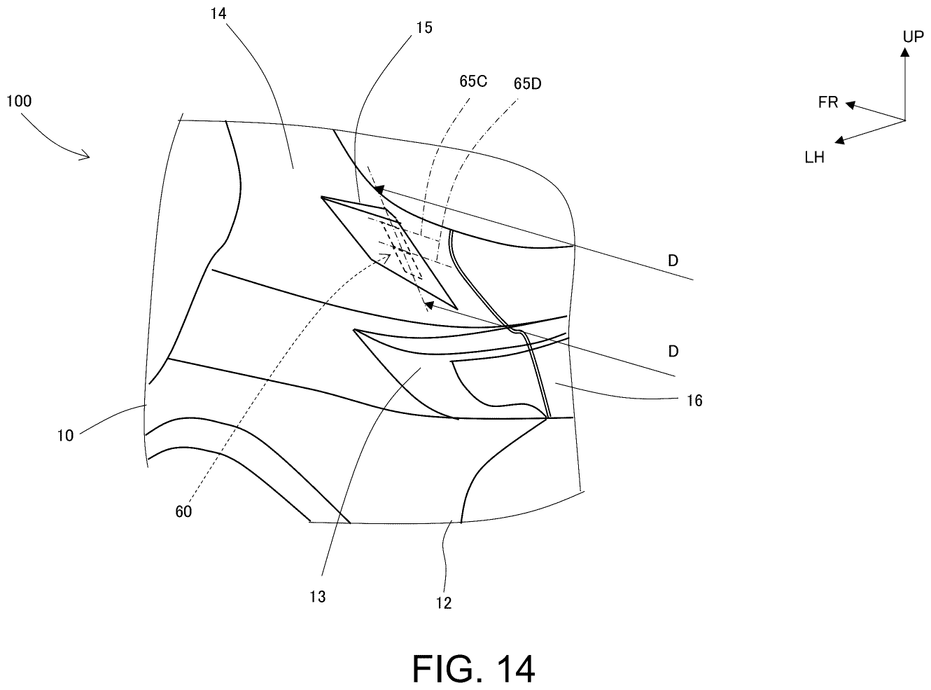

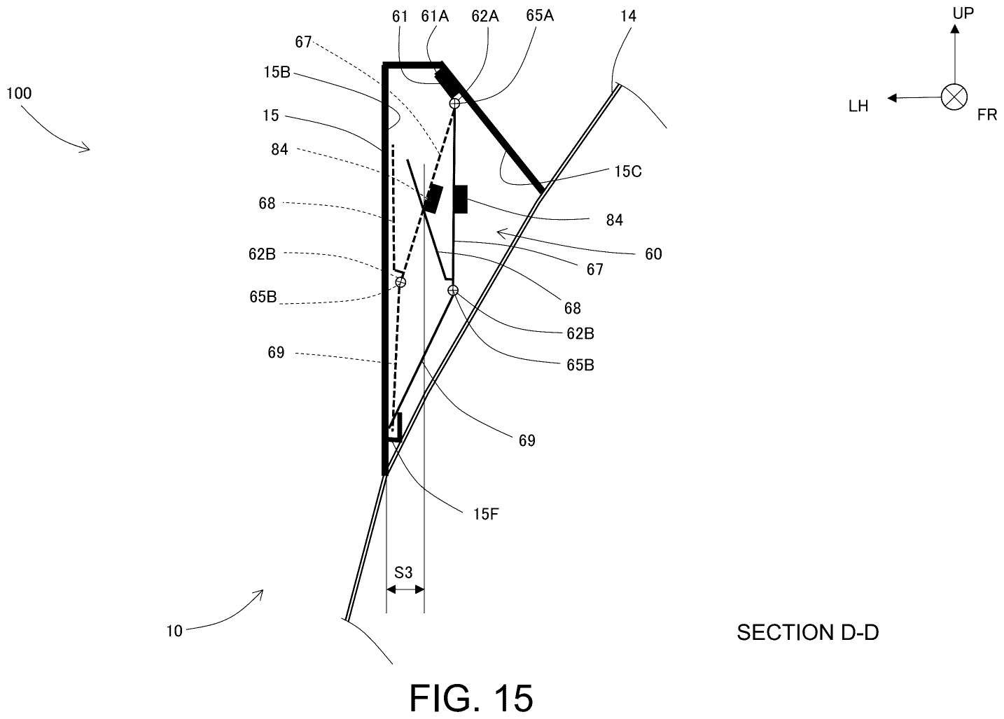

Next, an aerodynamic characteristic control device 60 according to a fifth embodiment will be described with reference to FIGS. 14 and 15. Like the aerodynamic characteristic control device 50, the aerodynamic characteristic control device 60 is disposed inside the side spoiler 15. As shown in FIG. 15, a groove portion 15F is provided at the lower end of the left inner surface 15B of the side spoiler 15.

As shown in FIG. 15, the aerodynamic characteristic control device 60 includes a base member 61, a first connecting member 62A, a second connecting member 62B, an arm 67, a first advancing/retracting plate 68, a second advancing/retracting plate 69, and a weight 84. The arm 67, the first advancing/retracting plate 68, and the second advancing/retracting plate 69 constitute an electrically conductive component of the aerodynamic characteristic control device 60. The arm 67 is a metal plate member. The first advancing/retracting plate 68 and the second advancing/retracting plate 69 are metal plate members, and have the same curved surface shape as the curved surface shape of the left inner surface 15B of the side spoiler 15.

The base member 61 is fixed to the right inner surface 15C of the upper portion of the side spoiler 15 with a double-sided tape 61A. The first connecting member 62A is connected to the left end of the base member 61. The first connecting member 62A has the same configuration as the first connecting member 52A of the aerodynamic characteristic control device 50 described above, includes the first rotation axis 65A, and rotatably connects the base member 61 and the arm 67. The arm 67 extends downward from the first connecting member 64A. Here, as shown in FIG. 14, the center line 65C of the first rotation axis 65A horizontally extends in the vehicle front-rear direction. The center line 65C is an imaginary line.

The second connecting member 62B is attached to the lower end of the arm 67. Similarly to the first connecting member 62A, the second connecting member 62B includes a second rotation axis 65B, and rotatably connects the lower end of the arm 67 and the upper end of the second advancing/retracting plate 69. The lower end of the second advancing/retracting plate 69 is inserted into the groove portion 15F of the side spoiler 15. Here, as shown in FIG. 14, the center line 65D of the second rotation axis 65B horizontally extends in the vehicle front-rear direction. The second rotation axis 65B is disposed parallel to the first rotation axis 65A.

The first advancing/retracting plate 68 is connected to a lower end of the arm 67, and extends upward from a connection portion with the arm 67. The first advancing/retracting plate 68 is attached to the arm 67 so as to be inclined so as to be in contact with the left inner surface 15B of the side spoiler 15 when the lower end of the arm 67 moves in the left direction.

In this way, the second connecting member 62B constitutes a bendable joint portion disposed between the upper end of the arm 67 and the lower end of the second advancing/retracting plate 69. Here, the arm 67, the first advancing/retracting plate 68, and the second advancing/retracting plate 69 constitute an electrically conductive component. Therefore, the upper end of the arm 67 constitutes one end of the electrically conductive component, and the lower end of the second advancing/retracting plate 69 constitutes the other end of the electrically conductive component. The second connecting member 62 constitutes a bendable joint portion disposed between one end and the other end of the electrically conductive component.

As shown in FIG. 15, when the vehicle 100 is traveling straight, the arm 67 hangs downward due to gravity. The second advancing/retracting plate 69 extends obliquely downward from the lower end of the arm 67 toward the groove portion 15F. Further, the first advancing/retracting plate 68 is at a position inclined obliquely leftward and upward from the lower end of the arm 67. The first advancing/retracting plate 68 and the second advancing/retracting plate 69 are bent toward the quarter panel 14. At this time, the average distance S3 between the first advancing/retracting plate 68 and the second advancing/retracting plate 69 and the left inner surface 15B of the side spoiler 15 is equal to or greater than the threshold value.

When the vehicle 100 turns to the right, if an acceleration in the left direction is applied, the arm 67 rotates clockwise around the first rotation axis 65A as indicated by a broken line in FIG. 15. As a result, the first advancing/retracting plate 68 approaches the left inner surface 15B of the side spoiler 15. At this time, the second advancing/retracting plate 69 rotates counterclockwise with respect to the arm 67 about the second rotation axis 65B. Further, the lower end of the second advancing/retracting plate 69 slides downward in the groove portion 15F. That is, when the acceleration in the left direction is applied, the lower end of the second advancing/retracting plate 69 slides inside the groove portion 15F when the arm 67 rotates with respect to the base member 51. As a result, the second connecting member 62B moves in the left direction, and the lower end of the arm 67, the lower end of the first advancing/retracting plate 68, and the upper end of the second advancing/retracting plate 69 approach the left inner surface 15B of the side spoiler 15. Therefore, the average distance S3 between the first advancing/retracting plate 68 and the second advancing/retracting plate 69 and the left inner surface 15B of the side spoiler 15 is less than the threshold value. When the acceleration in the left direction increases, the first advancing/retracting plate 68 and the second advancing/retracting plate 69 come into contact with the left inner surface 15B.

When the first advancing/retracting plate 68 and the second advancing/retracting plate 69 approach or contact the left inner surface 15B, the air charged by electrostatic induction is drawn to the left outer surface of the side spoiler 15. This reduces turbulence of air flowing out from the rear of the vehicle 100 when the vehicle 100 is turning to the right. Therefore, the fluctuating force acting on the vehicle 100 due to the disturbance of the air flow is reduced, and the steering stability during turning travel is improved.

In addition, the aerodynamic characteristic control device 60 moves the first advancing/retracting plate 68 and the second advancing/retracting plate 69 away from the left inner surface 15B of the side spoiler 15 so that the average distance S3 between the first advancing/retracting plate 68 and the second advancing/retracting plate 69 and the left inner surface 15B of the side spoiler 15 during straight traveling is equal to or greater than the threshold value. Therefore, similarly to the aerodynamic characteristic control device 50, the aerodynamic characteristic control device 60 can ensure steering stability during straight traveling by preventing the aerodynamic center of the vehicle 100 from moving rearward during straight traveling. As described above, the aerodynamic characteristic control device 60 can improve the steering stability of the vehicle 100 during turning travel and straight travel with a simple configuration.

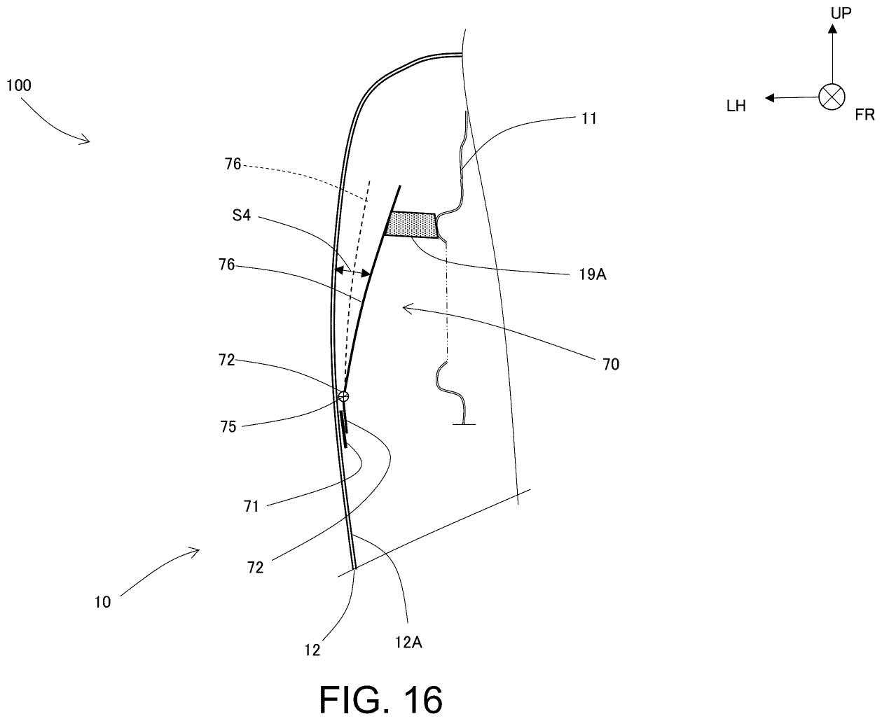

Next, an aerodynamic characteristic control device 70 according to a sixth embodiment will be described with reference to FIG. 16. First, the same components as those of the aerodynamic characteristic control device 20 described with reference to FIGS. 1 to 5 are denoted by the same reference numerals, and description thereof will be omitted. As shown in FIG. 16, in the aerodynamic characteristic control device 70, the arrangement of the base member 21 and the strip 26 of the aerodynamic characteristic control device 20 is reversed.

The aerodynamic characteristic control device 70 includes a base member 71, a connecting member 72, and a strip 76. The connecting member 72 is attached to an upper portion of the base member 71 and rotatably connects the strip 76 and the base member 71 around the rotation axis 75. A stopper 19A is attached to the side member 11 corresponding to the upper portion of the strip 76.

When the vehicle 100 is traveling straight, the strip 76 is inclined to the right so as to come into contact with the stopper 19A by gravity. At this time, the average distance S4 between the strip 76 and the inner surface 12A of the rear bumper 12 is equal to or greater than the threshold value.

When the vehicle 100 turns to the right, the strip 76 approaches the inner surface 12A of the rear bumper 12 due to the acceleration toward the left as indicated by the broken line in FIG. 16. As a result, the average distance S4 becomes less than the threshold value. When the acceleration increases, the strip 76 comes into contact with the inner surface 12A of the rear bumper 12.

The aerodynamic characteristic control device 70 has the same operation/effect as the aerodynamic characteristic control device 20.

In the aerodynamic characteristic control device 70, a weight 81 may be attached as in the aerodynamic characteristic control device 20A described with reference to FIG. 6. Alternatively, the weight portion may be formed by winding the upper end of the strip 76 a plurality of times.

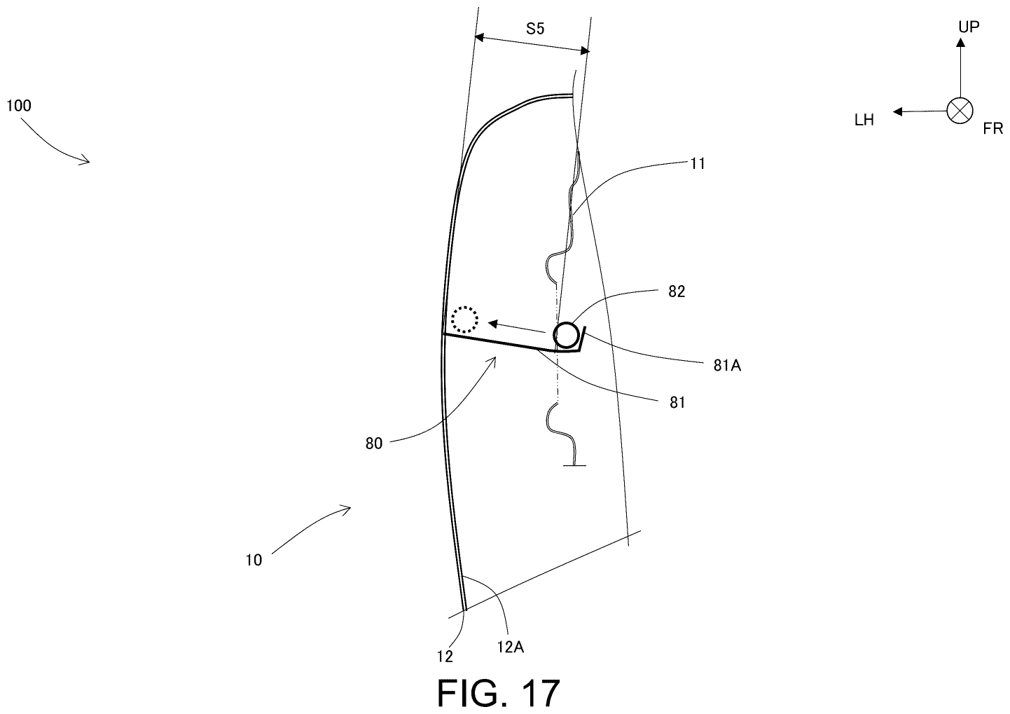

Next, an aerodynamic characteristic control device 80 according to a seventh embodiment will be described with reference to FIG. 17. As shown in FIG. 17, the aerodynamic characteristic control device 80 includes a rail 85 and a metal ball 86 as an electrically conductive component.

The rail 85 is a longitudinal member having a groove-shaped cross section and extends obliquely downward to the right from the inner surface 12A of the rear bumper 12. The rail 85 is provided with a stopper 85A at the right end.

When the vehicle 100 is traveling straight, the metal ball 86 is in contact with the stopper 85A at the right end of the rail 85. At this time, the distance S5 between the inner surface 12A and the metal ball 86 is equal to or larger than the threshold value.

When the vehicle 100 turns to the right, the metal ball 86 moves toward the inner surface 12A of the rear bumper 12 due to the acceleration in the left direction. As a result, the distance S5 between the inner surface 12A and the metal ball 86 becomes less than the threshold value. When the acceleration increases, the metal ball 86 comes into contact with the inner surface 12A of the rear bumper 12.

The aerodynamic characteristic control device 80 moves the metal ball 86 away from the inner surface 12A of the rear bumper 12 by a threshold value or more when the vehicle 100 is traveling straight, and moves the metal ball 86 toward the inner surface 12A during turning. Accordingly, the aerodynamic characteristic control device 80 can improve the steering stability of the vehicle 100 during turning travel and straight travel with a simple configuration.

In the above description, the aerodynamic characteristic control device 20, 20A, 30, 40, 70 and 80 is disposed inside the rear bumper 12, and the aerodynamic characteristic control devices 50, 50A, and 60 are disposed inside the side spoiler 15. For example, it may be disposed at the left and right side end portions of a resin-made air spoiler provided above the rear portion of the vehicle body 10, or may be disposed inside another vehicle exterior article. In addition, the side panel constituting the design surface of the side surface of the vehicle body 10 may be formed of resin, and the aerodynamic characteristic control device 20, 20A, 30, 40, 50, 50A, 60, 70 and 80 may be disposed inside the side panel.

1. An aerodynamic characteristic control device for a vehicle, comprising:
an electrically conductive component disposed on a rear side portion of a vehicle body and configured to be movable in a vehicle width direction according to an acceleration applied in the vehicle width direction to the vehicle body, wherein
the electrically conductive component moves in the vehicle width direction such that the electrically conductive component advances or retreats with respect to the inner surface of the vehicle body to maintain a distance between the electrically conductive component and an inner surface of the vehicle body equal to or larger than a threshold value during straight traveling and the distance smaller than the threshold value during turning.

2. The aerodynamic characteristic control device for a vehicle according to claim 1, comprising a base member attached to the inner surface of the vehicle body, wherein
one end of the electrically conductive component is rotatably attached to the base member, and the other end of the electrically conductive component is swung in the vehicle width direction due to rotation of the one end of the electrically conductive component with respect to the base member.

3. The aerodynamic characteristic control device for a vehicle according to claim 1, comprising a base member attached to the inner surface of the vehicle body, and a groove provided in the inner surface of the vehicle body, wherein
one end of the electrically conductive component is rotatably attached to the base member, and the other end of the electrically conductive component is slidably inserted into the groove;
the electrically conductive component further includes a bendable joint portion at a position located between the one end and the other end of the electrically conductive component, and
when the one end of the electrically conductive component rotates with respect to the base member, the other end of the electrically conductive component is slid within the groove to swing the joint portion in the vehicle width direction.

4. The aerodynamic characteristic control device for a vehicle according to claim 2, wherein
at least a part of the electrically conductive component has the same curved shape as a curved shape of the inner surface of the vehicle body.

5. The aerodynamic characteristic control device for a vehicle according to claim 3, wherein
at least a part of the electrically conductive component has the same curved shape as a curved shape of the inner surface of the vehicle body.

6. The aerodynamic characteristic control device for a vehicle according to claim 2, comprising a weight attached to the electrically conductive component.

7. The aerodynamic characteristic control device for a vehicle according to claim 3, comprising a weight attached to the electrically conductive component.
